(19) United States
(12) Patent Application Publication
(10) Pub. No.: US 2013/0304526 A1
(43) Pub. Date: Nov. 14, 2013

(54) METHODS FOR CROSS-SELLING FLIGHTS AND TRAVEL-RELATED GOODS

(71) Applicant: Switchfly, Inc., San Francisco, CA (US)

(72) Inventors: Christopher Boyd, Oakland, CA (US); Deren Baker, San Francisco, CA (US)

(73) Assignee: Switchfly, Inc., San Francisco, CA (US)

(21) Appl. No.: 13/891,949

(22) Filed: May 10, 2013

Related U.S. Application Data
(60) Provisional application No. 61/645,200, filed on May 10, 2012.

(51) Int. Cl. G06Q 10/02

(52) U.S. Cl. CPC G06Q 10/02
USPC 705/5

(57) ABSTRACT

One variation of a method for cross-selling flight reservations and travel-related goods includes: receiving a detail of a flight itinerary from a flight reservation interface of an airline; receiving a discounted fare for the flight itinerary; querying a travel-related good inventory system for a standalone price and a discounted price for a travel-related good based on the detail of the flight itinerary; calculating a package rate for the flight itinerary and the travel-related good according to the discounted fare of the flight itinerary and the discounted price of the travel-related good; calculating a savings amount for the package rate over a total standalone rate for the flight itinerary and the standalone price for the travel-related good; and returning a travel package comprising the travel-related good and a flight reservation specified in the flight itinerary, the package rate for the travel package, and the savings amount to the flight reservation interface.

This application claims the benefit of U.S. Provisional Application No. 61/645,200, filed on 10 May 2012, which is incorporated in its entirety by this reference.

### TECHNICAL FIELD

This invention relates generally to the field of travel discount programs, and more specifically to a new and useful method for cross-selling flights and travel-related goods in the field of travel discount programs.

### BACKGROUND

Internet technology has revolutionized opportunities for discounts and savings. Particularly in the airline company business, third-party websites that increase customer savings on flights and travel-related goods have become increasingly popular. Although such travel aggregation websites bring ample revenues to site managers and provide customers with discounts, airline company revenues may suffer from sales through these travel aggregation websites relative to sales through the airline company's own sales channels.

### BRIEF DESCRIPTION OF THE FIGURES

FIG. 1 is a flowchart representation a first method;

FIG. 2 is a flowchart representation of a variation of the first method;

FIG. 3 is a flowchart representation of a variation of the first method;

FIG. 4 is a flowchart representation of a variation of the first method;

FIG. 5 is a flowchart representation of a second method;

FIG. 6 is a flowchart representation of a variation of the second method;

FIG. 7 is a flowchart representation of a variation of the second method; and

FIG. 8 is schematic representation in accordance with variations of the first method and the second method.

### DESCRIPTION OF THE EMBODIMENTS

The following description of the embodiment of the invention is not intended to limit the invention to these preferred embodiments, but rather to enable any person skilled in the art to make and use this invention.

### 1. First Method

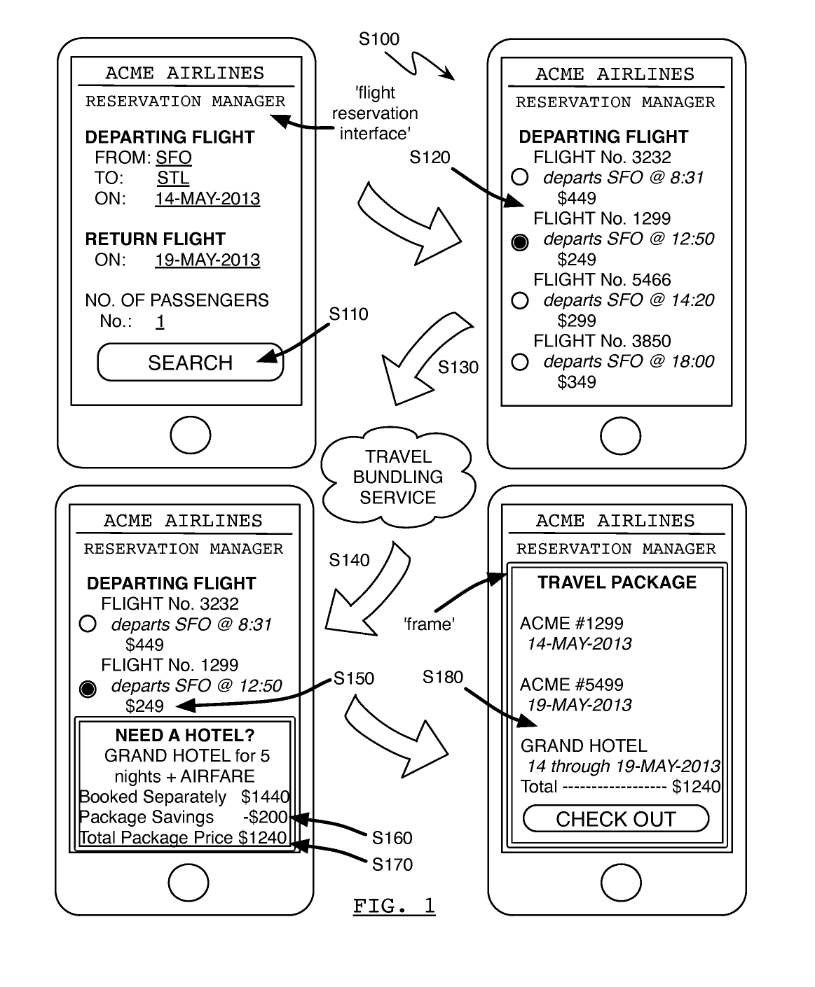

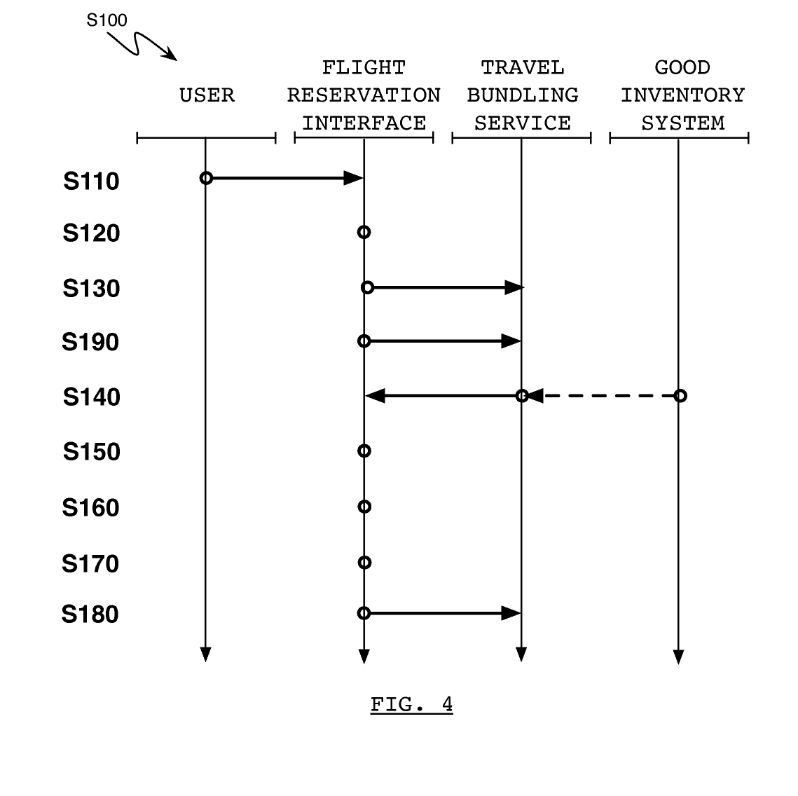

As shown in FIGS. 1 and 4, method S100 for cross-selling flights and travel-related goods includes: within a flight reservation interface of an airline, receiving a flight reservation search request from a customer in Block S110; retrieving a set of flight itineraries according to the reservation search request in Block S120, each flight itinerary in the set of flight itineraries specifying a flight served by the airline; submitting a package rate search request to a travel bundling service based on the flight reservation search request in Block S130; receiving a package rate for a particular flight itinerary in the set of flight itineraries in Block S140, the package rate specifying a travel-related good served by an external vendor; within the flight reservation interface, displaying a standalone rate for the particular flight itinerary in Block S150; within the flight reservation interface, displaying a savings amount for the package rate for the particular flight itinerary with the travel-related good in Block S160; and, in response to receiving a selection for the package rate for the particular flight itinerary with the travel-related good, directing the customer to a booking interface of the travel bundling service in Block S180.

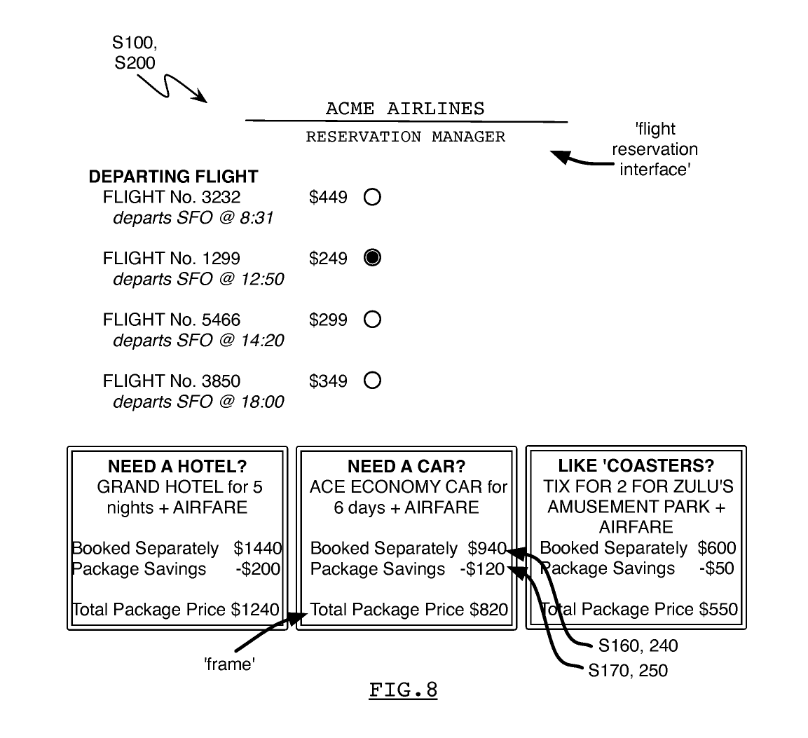

Generally, method S100 can be implemented within a flight reservation interface hosted by an airline company, such as a customer-facing website (shown in FIG. 8) or a customer facing native application (i.e., for a smartphone, for a tablet) (shown in FIG. 8) hosted by the airline company. The airline can implement method S100 through its own interface to enable customers to make flight reservations for flights served by the airline and to make reservations for other travel-related goods (e.g., a hotel, a rental car) served by external parties from within the same interface hosted by the airline. In particular, method S100 can enable the airline to offer a package deal, including a flight reservation and at least one other travel-related good, to a customer, and method S100 further enables the airline to advertise the package deal by displaying a level of savings available through the package deal relative to combined standalone costs of the flight reservation and one or more other travel-related goods. Method S100 can therefore enable the airline company to benefit from selling an airfare directly to a customer, such as by eliminating a reseller or a “middleman” from a transaction process, and method S100 can further enable the airline company to earn incremental increased revenue through sales of travel-related-goods from external parties.

As described above, method S100 can function to offer a package savings deal to a customer through what appears to be a website or other flight reservation interface hosted by a particular airline. Method S100 can thus enable the airline company (or other suitable primary travel service provider, such as a hotel provider) to offer package-saving deals, including travel-related goods from other travel service providers, through its own website. A “package savings deal” can refer to a bundle of airfare and one or more travel-related goods that are sold at a package rate, that is, sold at a discount when purchased together in comparison to a combined price of the airfare and the travel-related good(s) purchased separately. The package rate can therefore include a combined price that is less than the sum of the individual prices of the components of the package savings deal. The package savings deal can also include a discounted total price for airfare and the travel-related good. In one example, the travel-related good is rented lodging near an arrival (i.e., destination) airport specified in a flight itinerary of a selected airfare. The travel-related good can also or alternatively be a rental car, a vacation tour, an in-flight amenity, or any other suitable good associated with travel and/or vacation.

Although method S100 is described in terms of enabling an airline company to provide a package savings deal including a flight and at least one other travel-related good, method S100 can also be implemented by any other travel service provider to offer a package savings deal through its own website, native application, or other customer-facing interface. Generally, the package savings deal can be a discounted price of any suitable combination of travel-related goods, such as a hotel rental and car rental or an airfare and an in-flight amenity.

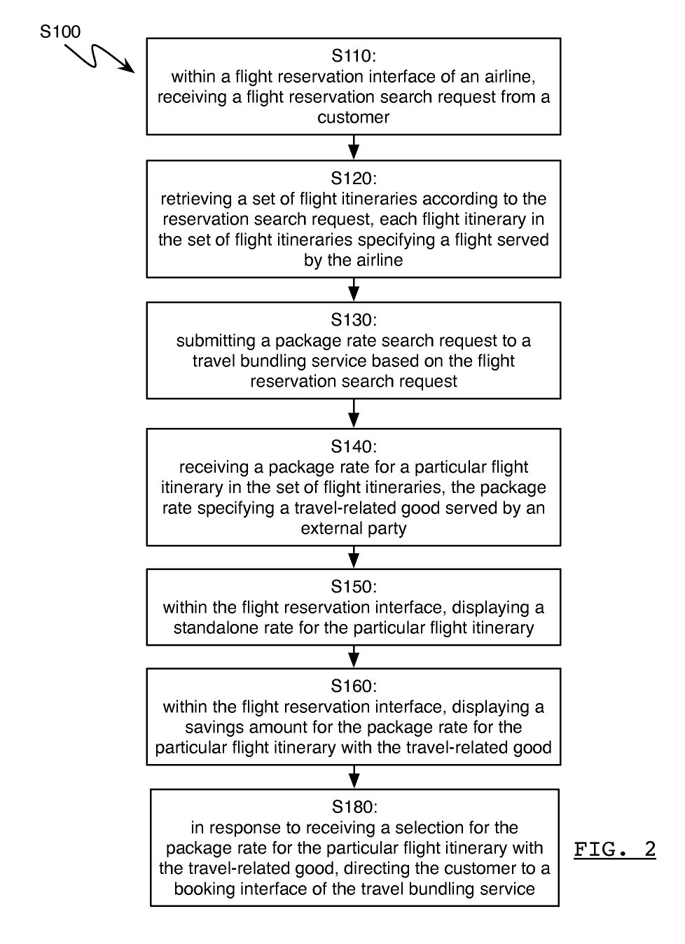

As shown in FIG. 2, Block S110 of method S100 recites, within a flight reservation interface of an airline, receiving a flight reservation search request from a customer. Generally, Block S110 functions to collect search criteria from a user such that the flight reservation interface can return relevant flights to the customer. For example, Block S110 can receive any one or more of a departure city or departure airport, an arrival city or an arrival airport, a departure date from the departure city, an arrival date from the arrival city (possibly the same as departure date from the departure city), a return date, a number of passengers, and/or a preferred class (e.g., business class, economy class). However, Block S110 can collect any other relevant search criteria from the user. Block S110 can receive the flight reservation search request through a website hosted by the airline, through a native application branded by the airline, or through any other suitable customer interface.

As shown in FIG. 2, Block S120 of method S100 recites retrieving a set of flight itineraries according to the reservation search request, each flight itinerary in the set of flight itineraries specifying a flight served by the airline. Generally, Block S120 functions to implement one or more criteria received in Block S110 to identify one or more flights that may be suitable for the customer and is provided by the airline. In one example, Block S110 can receive a departure date and a destination location from the customer, and Block S120 can retrieve a first flight itinerary specifying departure to the destination location in the morning on the departure date, a second flight itinerary specifying departure to the destination location in the afternoon on the arrival date, and a third flight itinerary specifying departure to the destination location in the evening on the departure date. In this example, Block S120 can additionally or alternatively retrieve a fourth flight itinerary specifying departure to the destination location on a day before the departure date and a fifth flight itinerary specifying departure to the destination location on a day after the departure date. Because various flights may be of different prices, by retrieving a set of flight itineraries, Block S120 can provide the customer with flight time and price choices such that the customer can select a combination of price and time that best suits his needs.

Block S120 can search the airlines internal flight database for flight itineraries that match or are a suitable alternative to one or more criteria collected in Block S110. For example, Block S120 can retrieve the set of flight itineraries from a remote server or remote database hosted by the airline. Alternatively, Block S120 can retrieve the set of flight itineraries from an airline-specific or airline-conglomerate-specific section of a government (e.g., federally) sanctioned database of flight itineraries. However, Block S120 can retrieve the set of flight itineraries from any other suitable source or sources and in any other suitable way.

As shown in FIG. 2, Block S130 of method S100 recites submitting a package rate search request to a travel bundling service based on the flight reservation search request. Generally, Block S130 initiates retrieval of one or more package rates for a flight itinerary by communicating details of the flight itinerary to a third-party service that handles travel packages substantially in real time. The travel bundling service can hold established relationships with various vendors of travel-related goods, can maintain a travel-related good inventory system, and/or can maintain connections to databases of various vendors of travel-related goods to enable bundling of a flight itinerary with one or more travel-related goods served by various vendors. For example, Block S130 can submit a departure date and destination location to the travel bundling service, and the travel bundling service can implement the foregoing travel information to query the travel-related good inventory system for available hotel rooms near the destination location and subsequently return an available hotel room. Therefore, Block S130 can submit the package rate search request to travel bundling service such that the airline company can access preexisting relationships with various vendors of travel-related goods through the travel bundling service rather than establishing its own direct partnerships with various vendors.

In one implementation Block S130 submits the package rate search request to the travel bundling service once Block S120 retrieves the set of flight itineraries. In this implementation, Block S130 can submit multiple package rate search requests, wherein each package rate search request specifies a particular flight itinerary returned in Block S120. Block S130 can thus select a subset of flight itineraries returned in Block S120, such as based on predicted probability of a customer purchase of the flight itineraries. For example, Block S130 can rank the flight itineraries returned in Block S120 based on customer purchase history, flight itinerary details, perceived customer sensitivity to flight itinerary details (e.g., price, flight arrival time, flight departure time), customer preferences, etc., and Block S130 can select the three flight itineraries with the highest conversion probabilities to submit to the travel bundling service. Block S130 can additionally or alternatively select a subset of flight itineraries returned in Block S120 based on reservation availability in the returned flight itineraries. For example, Block S130 can select two flight itineraries specifying flights with greater-than-average seat availability.

In another implementation Block S130 submits the package rate search request for a particular flight itinerary once the customer selects the particular flight itinerary within the customer-facing interface. For example, Block S120 can return the set of flight itineraries, the customer-facing interface can display the set of flight itineraries, and Block S130 can receive a customer selection for the particular flight itinerary from the set of flight itineraries and submit details of the particular flight itinerary to the travel bundling service. However, Block S130 can submit details of any other number or selection of flight itineraries to the travel bundling service at any other time or in response to any other event.

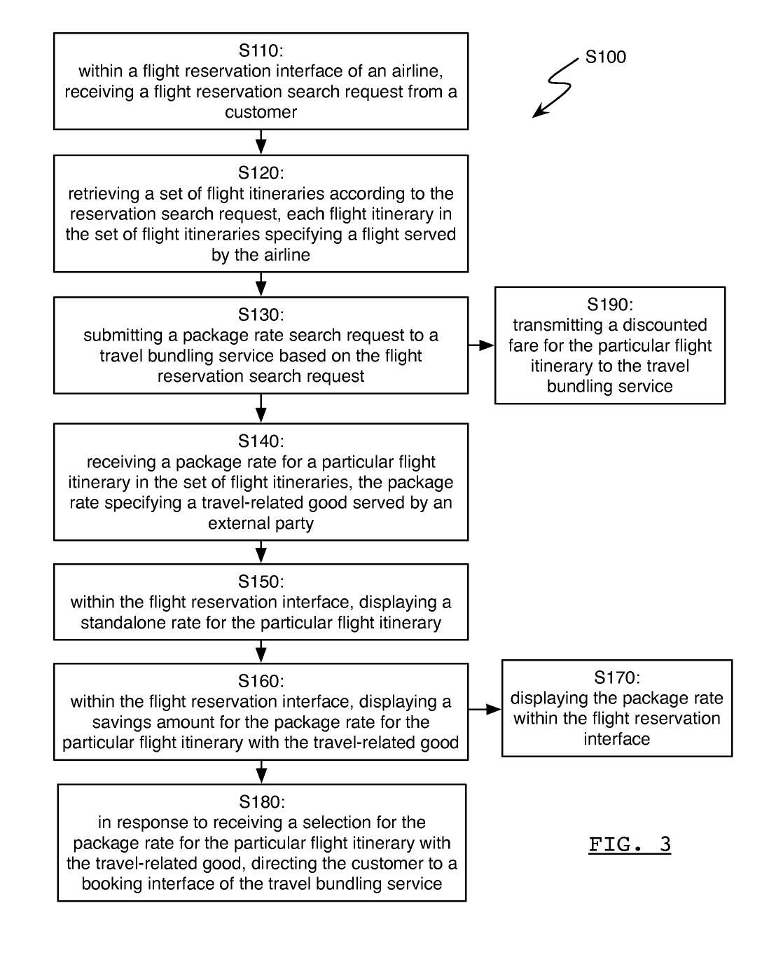

As shown in FIGS. 3 and 4, one variation of method S100 includes Block S190, which recites transmitting a discounted fare for the particular flight itinerary to the travel bundling service. Generally, Block S190 functions to provide a discounted rate for a flight itinerary to the travel bundling service such that the travel bundling service can generate the travel package with the flight itinerary priced at the discounted rate. In one implementation, a server hosting the flight reservation interface for the airline receives a discount rate request for the flight itinerary, and Block S190 responds to the request (e.g., through the server) by transmitting the discounted rate to the travel bundling service. In this implementation, Block S190 can select the discounted rate according to the type of travel-related good paired with flight itinerary, (a contract with) an external vendor serving the travel-related good, a projected or target savings for the package rate, etc. For example, Block S190 can receive a descriptor of the travel-related good paired with the flight itinerary, select a fare discount model, and input the type of travel-related good, seat availability on the flight specified by the flight itinerary, and a time before flight departure to set the discount rate (e.g., 10% off a standalone fare, $100 off a fare between $500 and $600) of the flight.

In another implementation, Block S190 submits the discounted fare for the flight itinerary with the package rate search request submitted in S130. In one example, Block S190 can submit a single discounted fare for the flight itinerary, and the travel bundling service can apply the discounted fare to any travel package including the flight itinerary. In another example, Block S190 can submit a maximum fare discount for the flight itinerary, and the travel bundling service can apply internal rules or an internal model to set the discounted fare up to the maximum fare discount, such as based on existing contracts with the airline and/or with the external vendor that serves the travel-related good. In yet another example, Block S190 can submit multiple discounted fares for the flight itinerary, and the travel bundling service can select a particular discounted fare to apply to the travel package, such as based on flight availability, availability of the travel-related good, customer transaction or travel history, the destination, and/or airline or external vendor rewards held by the customer, etc. However, Block S190 can transmit any other number and/or magnitude of discounted fare for a particular flight itinerary to the travel bundling service.

As shown in FIG. 2, Block S140 of method S100 recites receiving a package rate for a particular flight itinerary in the set of flight itineraries, the package rate specifying a travel-related good served by an external vendor. Generally, Block S140 functions to receive a package rate for a flight itinerary from the travel bundling service substantially in real time (i.e., soon after Block S130), wherein the travel bundling service generates the package rate by pairing the flight itinerary with at least one travel-related good served by other than the airline. The package rate can include details of the flight itinerary, such as destination location and departure date, and details of the travel-related good, such as check-in and check-out dates for the travel-related good that includes a hotel reservation. In one example, Block S140 receives the package rate that specifies a hotel reservation availability in or near the destination location on the arrival date, a departing flight arriving to the destination location on the check-in date, and a return flight departing from the destination location on the check-in date.

Block S140 can also receive package rate and standalone travel component pricings from the bundling service. For example, Block S140 can receive a package rate that specifies a combined reduced price for a flight reservation specified by the flight itinerary, a standalone price for the flight reservation (i.e., a price of the reservation if booked without another travel-related good or outside of the travel package), a standalone price for the travel-related good if booked individually, and a comparison between the reduced rate and the sum of the standalone prices for the flight reservation and for the travel-related good (i.e., an amount saved). However, Block S140 can function in any other way to receive the package rate and/or any other package-related data.

As shown in FIG. 2, Block S150 of method S100 recites, within the flight reservation interface, displaying a standalone rate for the particular flight itinerary. Similarly, Block S160 of method S100 recites, within the flight reservation interface, displaying a savings amount for the package rate for the particular flight itinerary with the travel-related good. Furthermore, one variation of method S100 includes Block S170, which recites displaying the package rate within the flight reservation interface. Generally, Blocks S150, S160, and S170 function to display bundled (i.e., packaged) travel component pricing, standalone travel component pricing, and/or a savings comparison between the bundled and standalone transactions options to the customer. In one implementation, Blocks S150, S160, and/or S170 display travel pricings in currency (e.g., dollar) format. In another implementation, Blocks S150, S160, and/or S170 display travel pricings in reward point format or in a combination format of reward points and currency. For example, Block S150 can include displaying a reward point-based standalone pricing for a selected flight itinerary, wherein the reward points are sourced from a reward account hosted by the airline and assigned to the customer. Block S170 can similarly include displaying a reward point-based package pricing for the selected flight itinerary, as well as a reward point-based package pricing for the travel-related good, wherein the latter reward points are sourced from a reward account hosted by the external vendor (e.g., a hotel chain) and assigned to the customer.

Block S150, S160, and/or S170 can display the travel component information within the flight reservation interface. In one example, Block S150 displays standalone rates for the set of flight itineraries within a list format, and Block S160 and Block S170 display the package rate and the savings rate within a frame (e.g., an iFrame) within the flight reservation interface, as shown in FIG. 1. In this example, content within the frame manipulated (i.e., controlled) by the travel bundling service, including the travel pricing information. Therefore, Blocks S160 and/or S170 can implemented within the flight reservation interface but specifically in a frame within the flight reservation interface, wherein the frame is controlled by the travel bundling service. However, Blocks S150, S160, and/or S170 can display travel pricing information in any other way or provide this information to the customer in any other suitable format.

Blocks S150, S160, and/or S170 can also display travel pricing information for multiple flight itineraries paired with one or more travel-related goods. For example, Blocks S150, S160, and/or S170 can display travel pricing information for a first flight itinerary departing on a morning of the departure date, and Blocks S150, S160, and/or S170 can simultaneously display travel pricing information for a second flight itinerary departing on in the evening of the departure date. Blocks S150, S160, and/or S170 can also display travel pricing information for a single flight itinerary paired with different travel-related goods. For example, Blocks S150, S160, and/or S170 can display a first standalone price, a first savings amount, and a first package price for a particular flight itinerary paired with a reservation for a first hotel, and Blocks S150, S160, and/or S170 can display a second standalone price, a second savings amount, and a second package price for the particular flight itinerary paired with a reservation for a second hotel and a reservation for a rental car from a rental car agency. However, Blocks S150, S160, and/or S170 can display travel pricing information for any other number or combinations of flight itineraries and travel-related goods.

As shown in FIG. 2, Block S180 of method S100 recites, in response to receiving a selection for the package rate for the particular flight itinerary with the travel-related good, directing the customer to a booking interface of the travel bundling service. Generally, Block S180 functions to direct the customer to a venue through which to purchase the travel package including a flight reservation specified in the flight itinerary and one or more travel-related goods when the customer selects the travel package. In one example, Block S170 displays the package rate and a description of contents of the travel package within the flight reservation interface open in a web browser, and Block S180 captures a mouse click on the description, communicates with the a flight reservation database of the airline to reserve the flight itinerary for a limited period of time, communicates with the travel bundling service to reserve the travel-related good for a limited period of time, and to directs the customer to an airline-branded booking interface webpage, hosted by the travel bundling service, through which to complete a transaction for the travel package. In another example, Block S170 displays the package rate and a description of contents of the travel package within the flight reservation interface open in an airline-branded native application executing on a smartphone, and Block S180 receives a touch input on the description, communicates with the a flight reservation database of the airline to reserve the flight itinerary for a limited period of time, communicates with the travel bundling service to reserve the travel-related good for a limited period of time, and to opens an airline-branded booking interface pop-up page, hosted by the travel bundling service within the native application, through which to complete a transaction for the travel package.

As described above, the flight reservation interface can include a frame within which Blocks S160 and/or S170 display the savings amount and the package rate for the travel package, and Block S180 can be implemented within the frame. Specifically, Block S180 can enable an intermediate booking interface within the flight reservation interface hosted by the airline such that the customer may remain within the same customer-facing interface to purchase the travel package, which includes both a flight itinerary served by the airline and a travel-related good served by an external vendor. For example, Block S180 can update the frame to display the intermediate booking interface within the flight reservation interface such that the frame functions as a portal. Content within the frame can also be branded for the airline, such that the intermediate booking interface appears to be contiguous with the airline-hosted content outside the frame. For example, Block S180 can apply airline-specific color palette, typeface, images, and/or design elements to content rendered within the frame. Therefore, Block S180 can update the frame to display the booking interface that is hosted by the travel bundling service (or other transaction service) and is branded for the airline, thereby enabling the customer to purchase a travel package, including a flight reservation served by the airline and a travel-related good served by an external vendor, through the same flight reservation interface hosted by the airline.

Alternatively, Block S180 can direct the customer to the booking interface that is external to the flight reservation interface hosted by the airline. For example, Block S180 can direct a web browser to a URL page hosted by the travel bundling service, wherein the URL page is branded for the airline. In this example, the URL page can include a ‘cancel’ button that, when selected, returns the customer to the airline's flight reservation interface and a ‘complete transaction’ button that, when selected, initiates a monetary transaction for the travel package, transmits booking confirmation to a booking server hosted by the airline, and transmits booking confirmation to a booking server hosted by the external vendor. Therefore, Block S180 can direct the customer to an external website or other external customer-facing interface through which to purchase the travel package, though the external customer-facing interface may be branded according to the airline such that the external customer-facing interface appears to a customer to be within the interface hosted by the airline. However, Block S180 can function in any other way to direct the customer to a booking interface of the travel bundling service in response to selection of the travel package for purchase.

### 2. Second Method

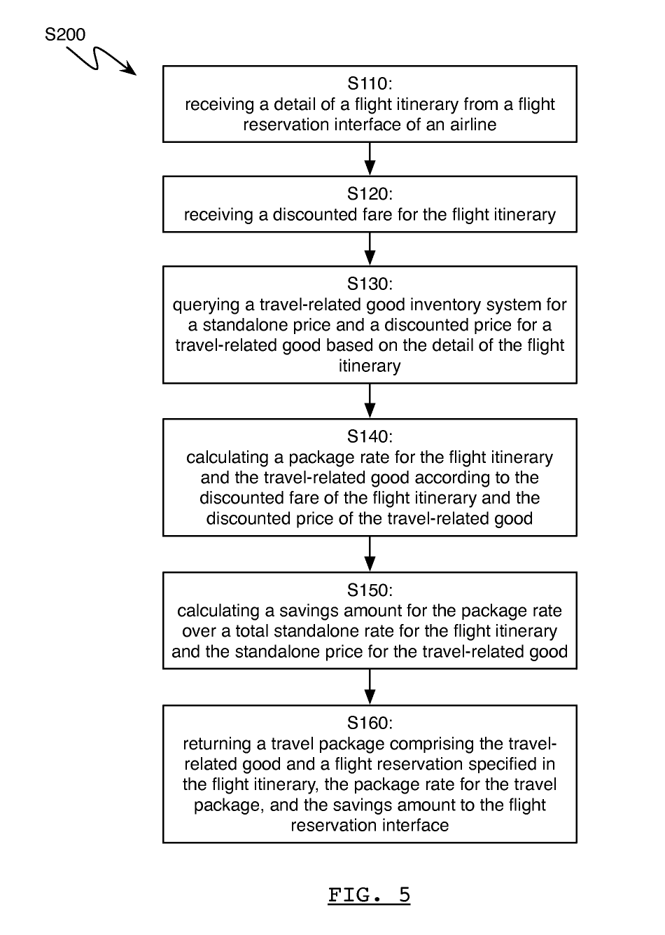

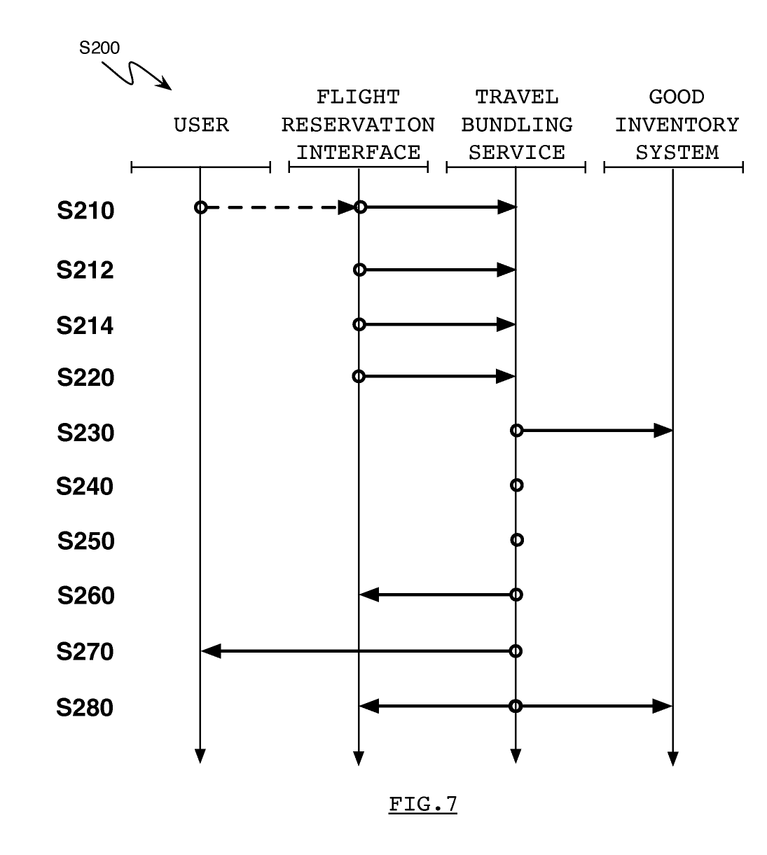

As shown in FIGS. 5 and 7, second method S200 for cross-selling flights and travel-related goods includes: receiving a detail of a flight itinerary from a flight reservation interface of an airline in Block S210; receiving a discounted fare for the flight itinerary in Block S220; querying a travel-related good inventory system for a standalone rate and a discounted price for a travel-related good based on the detail of the flight itinerary in Block S230; calculating a package rate for the flight itinerary and the travel-related good according to the discounted fare of the flight itinerary and the discounted price of the travel-related good in Block S240; calculating a savings amount for the package rate over a total standalone rate for the flight itinerary and the standalone rate for the travel-related good in Block S250; and returning the package rate and the savings amount to the flight reservation interface in Block S260.

Generally, second method S200 can be implemented by the travel bundling service described above to generate a travel package and to provide standalone pricing, package pricing, and/or savings figures for a flight itinerary served by an airline. Second method S200 can output this data through a third-party website linked to a flight reservation website hosted by the airline, within a frame (e.g., iframe) of a flight reservation interface hosted by the airline (shown in FIGS. 1 and 8), through a pop-up page with a native application hosted by the airline, or through or within any other customer-facing interface or electronic system. The travel bundling service communicate with a server hosting the airline's flight reservation interface and/or with a database containing flight itineraries and availabilities of the airline. The travel bundling service can further support (i.e., include) an application programming interface (API) communicatively coupled to one or more databases of vendors of travel-related goods. For example, second method S200 can enable an airline company to access preexisting relationships with various vendors of travel-related goods through the travel bundling service, thereby liberating the airline from the task of establishing its own direct partnerships with the various vendors. In one implementation, the travel bundling service communicates with a Global Distribution System (GDS) that provides a networked database of travel-related goods, and second method S200 communicates with the database of travel-related goods through the DGS to generate travel packages for flights served by the airline. However, second method S200 can communicate with any suitable travel services database and/or over any other network.

As described above, second method S200 can support a branded or cobranded booking interface through which a customer may purchase a travel package. The booking interface can apply a typeface, color palette, images, and/or design elements associated with the airline such that the booking interface include branding unique to the airline, or the booking interface can also include brand elements for the travel bundling service such that the booking interface is cobranded with both airline and travel bundling service elements. Therefore, second method S200 can implement color schemes, logos, fonts, etc. such that the booking interface appears to belong to the airline. Additionally or alternatively, the flight reservation interface hosted by the airline can contain a widget, frame, or other suitable customer interactive feature that interfaces with the travel bundling service to display outputs of second method S200 to the customer.

As shown in FIG. 5, Block S210 of second method S200 recites receiving a detail of a flight itinerary from a flight reservation interface of an airline. Generally, Block S120 functions to gather data relevant to the customer's potential flight arrangements such that subsequent Blocks of second method S200 can generate a package travel deal. In one example, the flight reservation interface displays fields for flight itinerary information that the customer can enter to search for a flight within the flight reservation interface. Flight itinerary information can include a number of passengers, age of the passenger(s), a date of departure (or a range of dates of departure), a time of departure (or a range of times of departure), a date of arrival (or a range of dates of date of arrival), a time of arrival (or a range of times of arrival), a departure location, an arrival (i.e., destination) location, and/or a price for the flight. Flight itinerary information can additionally or alternatively include a customer identifier, such as a full name, a customer or rewards username, a password, an email address, a cell phone number, an IP address, an electronic serial number, a birthday, a mailing address, a social security number, a driver's license number, a photograph, a video, an identifying clipart, an answer to a secret question, a financial instrument (e.g., a credit card), an account number, a biometric datum, and/or any other suitable data identifying one or more travelers. As described above the flight reservation interface can implement the entered flight itinerary information to generate an list (or array) of possible flight itineraries from which the customer can select a desired flight itinerary. Block S210 can then receive the selected flight itinerary, such as over a secure web service.

Block S210 can function to initiate second method S200 by collecting information pertaining to a customer's potential travel needs, including details of a flight itinerary. Block S210 can receive flight itinerary information before the customer purchases airfare (i.e., makes a flight reservation for the flight specified by the flight itinerary) through the flight reservation interface. In one example, the customer can input flight parameters (e.g., departure and destination cities or airports, departure date, arrival date, and number of passengers), and an airline database can return available flight itineraries relevant to the customer's search terms. The flight reservation interface can display the returned flight itineraries, and Block S210 can receive a flight itinerary (or multiple flight itineraries) selected by the flight reservation interface. Block S210 can also receive flight itinerary information after the customer selects a particular flight itinerary from the set of flight itineraries presented by the airline through the flight reservation interface, as described above. For example, Block S210 can execute through a frame within the flight reservation interface, as described above, and retrieve a flight itinerary selection entered by the customer through the flight reservation interface. Through subsequent Blocks, second method S200 can subsequently pair one or more selected flight itineraries with one or more travel-related goods served by an external provider.

Block S210 can receive select itinerary information, such as arrival date, arrival location, stay duration, and number of passengers. For example, the flight reservation interface can extract this information from the customer's search terms and transmit this data to the travel bundling service. Alternatively, Block S210 can extract flight-related information from the received flight itinerary. For example Block S210 can parse through the flight itinerary to extract information relevant to generation of a package savings deal. The package savings deal cab include a discounted price for a sale of a combination of airfare and rented lodging (e.g. a hotel, a motel, a hostel, a rented home, or any other suitable form of rented or temporary lodging), or any suitable combination of two or more travel-related goods. In one implementation, Block S210 extracts the departure location and the arrival location from the flight itinerary such that subsequent Blocks of second method S200 can implement this data to pair the flight itinerary with rented lodging near the departure location and/or near the arrival location. Block S210 can also extract a number of passengers from the flight itinerary such that subsequent Blocks of second method S200 to select a size of magnitude of the travel-related good to pair with the flight itinerary. Block S210 can further extract a length of stay from the flight itinerary, which can enable subsequent Blocks of second method S200 to price a standalone cost and savings for a reservation with a lodging vendor.

However, Block S210 can extract any other information from the flight itinerary, such as information specific to selection of a particular type of travel-related good. For example, if the customer is traveling to a vacation locale well-known for amusement parks, Block S210 may extract an age of the customer from the flight itinerary because the customer's age may be relevant in selecting a travel-related good for the travel package. In this example, a subsequent Block of second method S200 may select the travel-related good that includes a ticket for an amusement park for flight itinerary that specifies one child between the ages of 6 and 14. However, Block S210 can receive or extract any other travel information in any other way and through any other communication channel.

As shown in FIG. 5, Block S220 of second method S200 recites receiving a discounted fare for the flight itinerary. Generally, Block S220 functions to retrieve a lower rate for an airfare specified in the flight itinerary to assist in generation of the package savings deal. For example, Block S220 can send a request for a discounted fare for the flight itinerary to a database (e.g., airline GDS through an API) supporting the flight reservation interface, and the database can return one discount rate, a maximum discount rate, a discount model, and/or a set of discount rates, etc. (i.e., discount information), such as through Block S190 described above. In one implementation, Block S220 transmits the request for the discounted fare after the flight itinerary is received. In this implementation, Block S220 can send details of the travel-related good paired with the flight itinerary with the discount fare request. For example, the airline database can implement details of the travel-related good to set the discounted price of the airfare. Alternatively, Block S220 can receive the discounted fare substantially simultaneously with receipt of the flight itinerary in Block S210. In this implementation, Block S220 can receive discount information preset by the database (or the airline).

Block S220 can further set the discounted fare based on the received discount information. For example, Block S220 can set the discounted airfare by applying a single received discount rate or by setting a discount rate dependent on the type or characteristic of the travel-related good. Block S220 can set the discounted airfare according to a date of travel, a time of travel, a location of travel, a revenue share model between the airline, the external vendor, and/or the travel bundling service, a customer-related parameter, or any other flight-related information that may impact a salability of the airfare and/or the travel package to the customer. For example, if a customer holds a premier membership with an airline company, Block S220 can retrieve this information from the flight reservation interface and apply the customer's premier membership to offer greater savings in package savings deal.

Block S220 can further extract a standalone rate for the airfare from the flight itinerary, or Block S220 can query a database or server associated with the airline for a standalone rate for the flight itinerary.

Block S220 can also terminate the package savings deal if a discounted rate for the airfare is not returned by the airline company. Furthermore, in addition to sending a request for the discounted fare for the flight itinerary to the database affiliated with the airline, Block S220 can extract the standalone rate for the airfare, specified in the flight itinerary, from the flight itinerary. However, Block S220 can function in any other way to request, receive, and/or extract a discounted fare and/or a standalone fare for a flight specified in the flight itinerary.

As shown in FIG. 5, Block S230 of second method S200 recites querying a travel-related good inventory system for a standalone price and a discounted price for a travel-related good based on the detail of the flight itinerary. Generally, Block S230 functions to identify a travel-related good that can be paired with the flight itinerary to generate a package savings deal. Block S230 can therefore include querying various vendors of travel-related goods for standalone and discount prices. For example, Block S230 can cooperate with Block S220 to determine that the customer will be in a destination city for five nights, and Block S230 can predict that the customer will need a hotel room for those five nights and thus transmit a query to various rented lodging vendors (e.g., hotels, motels) within the destination city for available lodging during the five-day period. In this example, Block S230 can subsequently generate one or more travel packages including a flight itinerary and a paired (e.g., matched) hotel reservation based on availability (and magnitude) of discount rates for the airfare and for the hotel reservation.

Block S230 can also include sending a search request to the travel-related good inventory system for the travel-related good based on the detail of the flight itinerary. In particular, Block S230 can transmit a request for a travel-related good match for the flight itinerary to the travel-related good inventory system. Alternatively, Block S230 can select a type of travel-related good to pair with the flight itinerary (e.g., a hotel, a rental car, or a tour package), select travel-related good criteria (e.g., dates and location), and submit a query to the travel-related good inventory system for the selected type of travel-related good that meets the selected travel-related good criteria.

Block S230 can query a database maintained by a vendor of a travel-related good (i.e., the external vendor), wherein the database is pre-populated with standalone rates and/or discounted rates for one or more travel-related goods served by the vendor. Additionally or alternatively, Block S230 can call a vendor of a type of a travel-related good (e.g., a hotel server or manager) to request a discount price, such as for a specific combination with a particular flight itinerary. Block S230 can also receive a maximum discount rate, a discount model, and/or a set of discount rates, etc. from the vendor and calculate a discount rate for the travel-related good directly, such as similar to Block S220 described above. For example, Block S230 can receive a baseline rate for the travel-related good, apply a standalone markup rate to calculate the standalone rate for the travel-related good, and apply a discount markup rate to calculate the discounted price for the travel-related good. In this example, Block S230 can apply a markup rate to a baseline rate of the travel-related good according to at least one of the arrival location, the arrival date, and the number of passengers, and a contract held by the airline. Block S230 can therefore apply internally-managed markup rules to the package rate and/or to the standalone rate for the travel-related good. Block S220 can apply similar internally-managed markup rules to the package rate and/or to the standalone rate for the airfare.

Block S230 can submit a query for a standalone price and a discounted price for each of a set of travel-related goods, such as from one vendor or from multiple vendors. In this implementation, Block S230 can further select a subset of the set of travel-related goods to pair with one or more flight itineraries, such as based on a level of savings offered through combination with the airfare. However, Block S230 can function in any other way to retrieve standalone price and a discounted price for a travel-related good.

As shown in FIG. 5, Block S240 of second method S200 recites calculating a package rate for the flight itinerary and the travel-related good according to the discounted fare of the flight itinerary and the discounted price of the travel-related good. Generally, Block S240 functions to determine (e.g., estimate, calculate, extrapolate) a total cost of the travel package by summing the discounted rate of the airfare specified in the flight itinerary and the discounted price of the travel-related good(s). However, Block S240 can function in any other way to calculate a package rate for the travel package.

As shown in FIG. 5, Block S250 of second method S200 recites calculating a savings amount for the package rate over a total standalone rate for the flight itinerary and the standalone price for the travel-related good. Generally, Block S250 functions to determine an amount of savings available to the customer through the travel package in comparison to the sum cost of the airfare and the travel-related good(s) if purchased separately. In particular, Block S240 can function to quantify a discount available through purchase of the travel package that includes both the airfare and the travel-related good(s) by subtracting the package rate (i.e., the sum of the discounted price of the airfare and the discounted price of the travel-related good) from the sum of the standalone price of the airfare and the standalone price of the travel-related good. However, Block S250 can function in any other way to calculate the savings amount for the package rate.

As shown in FIG. 5, Block S260 of second method S200 recites returning the package rate and the savings amount to the flight reservation interface. Generally, Block S260 functions to communicate travel package information to and/or through the flight reservation interface such that the travel package information can be access by the customer. In one implementation, Block S260 includes displaying the package rate and the savings amount within a frame inside the flight reservation interface. For example, Block S260 can display travel package information through an iframe installed within the flight reservation interface such that the customer can view the standalone airfare price provided by the airline, the negotiated package rate generated by second method S200, and the savings amount for the package rate all through the flight reservation interface. However, Block S260 can communicate (e.g., display) travel package information through any other widget, radio button, website page, native application interface, etc. associated with or accessible through the flight reservation interface. For example, Block S260 can display details of the travel package within a co-branded widget, a co-branded radio button, or a co-branded portion of a website hosted by the airline company.

As described above, Block S260 can display the package savings deals with an frame on the flight reservation interface. For example, the frame can be an iframe that includes an HTML document embedded within another HTML document, and the iframe can be arrange near the bottom of the flight reservation interface. In this example, once a customer navigates to the iframe, the iframe can be populated with a list or tiled representations of the package savings deals, as shown in FIG. 8.

In one implementation, Block S260 displays multiple package savings deals. For example, Block S230, S240, and S250 can generate a set saving packages and calculate package rates and savings rates for each, and Block S260 can display the set of savings packages through the frame within the flight reservation interface, such as in order or savings amount with the saving package with the greatest savings at the top of the list of savings packages. Thus, Block S260 can enable the customer to review and compare multiple package savings at once.

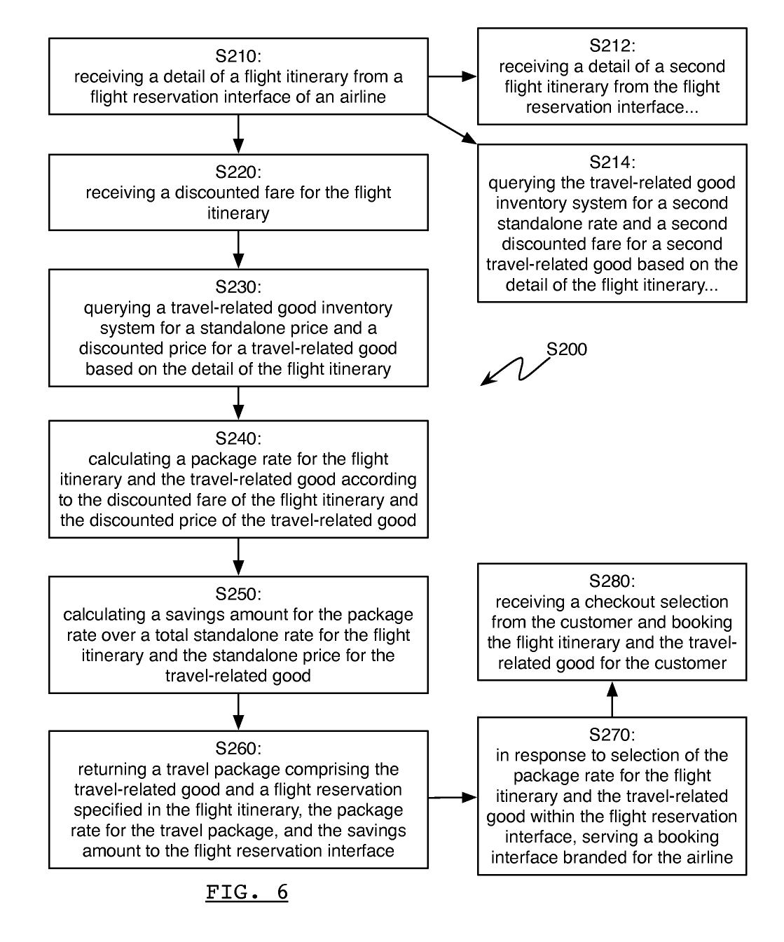

As shown in FIG. 6, one variation of second method S200 includes Block S212, which recites receiving a detail of a second flight itinerary from the flight reservation interface, receiving a second standalone rate and a second discounted fare for the second flight itinerary, querying the travel-related good inventory system for a second standalone rate and a second discounted fare for a second travel-related good based on the detail of the second flight itinerary, calculating a second package rate for the second flight itinerary and the second travel-related good according to the second discounted fare of the second flight itinerary and the second discounted fare of the second travel-related good, and calculating a second savings amount for the second package rate over a total second standalone rate for the second flight itinerary and a second standalone rate for the second travel-related good. Block S212 can therefore mimic Blocks S210, S220, S230, S240, and S250 for a second flight itinerary. In this variation, Block S260 can further include displaying the second package rate and the second savings amount adjacent the package rate and the savings amount within the flight reservation interface (e.g., within the frame).

Similarly, as shown in FIG. 5, one variation of second method S200 includes Block S214, which recites querying the travel-related good inventory system for a second standalone rate and a second discounted fare for a second travel-related good based on the detail of the flight itinerary, calculating a second package rate for the flight itinerary and the second travel-related good according to the discounted fare of the flight itinerary and the second discounted fare of the second travel-related good, and calculating a second savings amount for the second package rate over a total standalone rate for the flight itinerary and a second standalone rate for the second travel-related good. Block S214 can therefore mimic Blocks S230, S240, and S250 for a second travel-related good for a particular flight itinerary. In this variation, Block S260 can further include displaying the second package rate in line with the package rate within the flight reservation interface (e.g., within the frame). Block S270 can similarly display the second package rate in line with the package rate within the booking interface.

Block S260 can also update the flight reservation interface with additional travel-related good components in response to subsequent good selections. For example, Blocks S210, 220, 230, 240, 250, and 260 can cooperate to generate and display an airfare and hotel package for a customer. In the example, in response to selection of the airfare and hotel package, Blocks S210, 220, 230, 240, 250, and 260 can repeat to generate and display a second package including the selected airfare and hotel package and a rental car. Furthermore, in response to selection of the second package, Blocks S210, 220, 230, 240, 250, and 260 can again repeat to generate and display a third package including the second package and a tour package. Thus, second method S200 can repeat for subsequent travel package selections to build a discount package including multiple travel-related goods at discount prices.

As shown in FIG. 6, one variation of second method S200 includes Block S270, which recites, in response to selection of the package rate for the flight itinerary and the travel-related good within the flight reservation interface, serving a booking interface branded for the airline. Generally, Block S270 functions to direct the customer to a booking interface through which to purchase a travel package once the customer selects the travel package from within the flight reservation interface.

In one implementation, once the customer selects a package savings deal within the flight reservation interface, Block S270 can direct the customer to a booking page with a website hosted by the travel bundling service and cobranded with the airline such that the booking page appears as part of the airline's webpage. Block S270 can thus direct the customer to the booking page through which the customer may purchase a selected package savings deal or return to the flight reservation interface hosted by the airline. Alternatively, Block S260 can display details of the travel within a frame inside the flight reservation interface, and Block S270 can update the frame with an intermediate booking interface such that the customer can purchase the travel package without leaving the flight reservation interface. However, Block S270 can function in any other way to serve a booking interface branded for the airline to the customer to enable the customer to purchase a selected travel package.

As shown in FIG. 6, one variation of second method S200 further includes Block S280, which recites receiving a checkout selection from the customer and booking the flight itinerary and the travel-related good for the customer. Generally, Block S280 function to receive a selection for a travel package from the customer, to receive payment information from the customer, and to communicate corresponding reservation confirmations to the airline and to the travel-related good vendor on behalf of the customer. For example, Block S280 can implement standard online checkout methods to complete a transaction with the customer in exchange for confirmation of airfare and travel-related good reservations.

Block S280 can enable the customer to provide currency-based payment for the travel package, such as with a credit card or with a debit card. Block S270 can also handle communication of reward (i.e., loyalty) points between the booking interface and an airline reward database to enable the customer to pay for the travel package with airline-specific reward points while outside of the airline's flight reservation interface. However, Block S280 can function in any other way to receive a checkout selection from the customer and to book the travel package for the customer.

Generally, first method S100 and second method S200 are described above in the context of generating a travel package including an airfare paired with another travel-related good. However, first method S100 and second method S200 can be implemented in other applications to generate a travel package including two similar or dissimilar travel-related goods, such as a tour package and a car rental or hotel accommodations and an in-flight amenity. First method S100 and the second method S200 can also pair a flight itinerary with a travel-related good and advertise the travel-related good at a discount price if purchased with the flight itinerary through the flight reservation interface hosted by the airline without a discounted airfare rate. For example, second method can display a standalone airfare rate, a standalone hotel rate, a hotel savings rate if purchased with the airfare at the standalone airfare rate, and a package price of the airfare if purchased with the airfare at the standalone airfare rate. However, first method S100 and second method S200 can function in any other way to enable an airline to cross-selling flight reservations and travel-related goods through its own customer-facing interface.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, native application, frame, iframe, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for cross-selling flight reservations and travel-related goods comprising:
receiving a detail of a flight itinerary from a flight reservation interface of an airline;
receiving a discounted fare for the flight itinerary;
querying a travel-related good inventory system for a standalone price and a discounted price for a travel-related good based on the detail of the flight itinerary;
calculating a package rate for the flight itinerary and the travel-related good according to the discounted fare of the flight itinerary and the discounted price of the travel-related good;
calculating a savings amount for the package rate over a total standalone rate for the flight itinerary and the standalone price for the travel-related good; and
returning a travel package comprising the travel-related good and a flight reservation specified in the flight itinerary, the package rate for the travel package, and the savings amount to the flight reservation interface.

2. The method of claim 1, wherein returning the travel package, the package rate and, the savings amount to the flight reservation interface comprises displaying the package rate and the savings amount within a frame inside the flight reservation interface.

3. The method of claim 2, further comprising receiving a detail of a second flight itinerary from the flight reservation interface, receiving a second standalone rate and a second discounted fare for the second flight itinerary, querying the travel-related good inventory system for a second standalone rate and a second discounted price for a second travel-related good based on the detail of the second flight itinerary, calculating a second package rate for the second flight itinerary and the second travel-related good according to the second discounted fare of the second flight itinerary and the second discounted price of the second travel-related good, calculating a second savings amount for the second package rate over a total second standalone rate for the second flight itinerary and a second standalone rate for the second travel-related good, and displaying the second package rate and the second savings amount adjacent the package rate and the savings amount within the frame.

4. The method of claim 1, wherein querying a travel-related good inventory system comprises sending a search request to the travel-related good inventory system for the travel-related good based on the detail of the flight itinerary.

5. The method of claim 1, further comprising, in response to selection of the package rate for the flight itinerary and the travel-related good within the flight reservation interface, serving an booking interface branded for the airline.

6. The method of claim 5, further comprising querying the travel-related good inventory system for a second standalone rate and a second discounted price for a second travel-related good based on the detail of the flight itinerary, calculating a second package rate for the flight itinerary and the second travel-related good according to the discounted fare of the flight itinerary and the second discounted price of the second travel-related good, calculating a second savings amount for the second package rate over a total standalone rate for the flight itinerary and a second standalone rate for the second travel-related good, and displaying the second package rate in line with the package rate within the booking interface.

7. The method of claim 5, further comprising receiving a checkout selection from the customer and booking the flight itinerary and the travel-related good for the customer.

8. The method of claim 1, wherein receiving the detail of a flight itinerary from the flight reservation interface comprises receiving the flight itinerary from the flight reservation interface and extracting an arrival location, an arrival date, and a number of passengers from the flight itinerary.

9. The method of claim 8, wherein calculating the package rate for the flight itinerary and the travel-related good comprises applying a markup rate to a baseline rate of the travel-related good according to at least one of the arrival location, the arrival date, and the number of passengers, and a contract held by the airline.

10. The method of claim 8, wherein querying the travel-related good inventory system comprises receiving a baseline rate for the travel-related good, applying a standalone markup rate to calculate the standalone rate for the travel-related good, and applying a discount markup rate to calculate the discounted price for the travel-related good.

11. The method of claim 1, wherein receiving the discounted fare for the flight itinerary comprises sending a request for the discounted fare for the flight itinerary to a database affiliated with the airline and extracting the standalone rate for an airfare, specified in the flight itinerary, from the flight itinerary.

12. A method for cross-selling flight reservations and travel-related goods comprising:
within a flight reservation interface of an airline, receiving a flight reservation search request from a customer;
retrieving a set of flight itineraries according to the reservation search request, each flight itinerary in the set of flight itineraries specifying a flight served by the airline;
submitting a package rate search request to a travel bundling service based on the flight reservation search request;
receiving a package rate for a particular flight itinerary in the set of flight itineraries, the package rate specifying a travel-related good served by an external vendor;
within the flight reservation interface, displaying a standalone rate for the particular flight itinerary;
within the flight reservation interface, displaying a savings amount for the package rate for the particular flight itinerary with the travel-related good; and
in response to receiving a selection for the package rate for the particular flight itinerary with the travel-related good, directing the customer to a booking interface of the travel bundling service.

13. The method of claim 12, wherein receiving the flight reservation search request from the customer comprises receiving a departure date and a destination location, wherein retrieving the set of flight itineraries comprises retrieving a second flight itinerary specifying departure to the destination location on a day before the departure date, the particular flight itinerary specifying departure to the destination location on the arrival date, and a third flight itinerary specifying departure to the destination location on a day after the departure date, wherein displaying the savings amount for the package rate for the particular flight with the travel-related good further comprises displaying a savings amount for a package rate for the second flight with a second travel-related good and a savings amount for a package rate for the third flight with a third travel-related good.

14. The method of claim 12, wherein submitting the package rate search request to the travel bundling service comprises receiving a selection for the particular flight itinerary and submitting details of the particular flight itinerary to the travel bundling service.

15. The method of claim 12, wherein receiving the flight reservation search request from the customer comprises receiving an arrival date and an arrival location, wherein receiving the package rate for the particular flight comprises receiving a hotel reservation availability on the arrival date and in the arrival location.

16. The method of claim 12, wherein displaying the standalone rate for the particular flight itinerary comprises displaying the standalone rate for the particular flight itinerary in-line with standalone rates for other flight itineraries in the set of flight itineraries.

17. The method of claim 12, wherein displaying the savings amount for the package rate for the particular flight with the travel-related comprises displaying the package rate and the savings amount for the package rate within a frame inside the flight reservation interface, content within the frame manipulated by the travel bundling service.

18. The method of claim 17, wherein directing the customer to the booking interface of the travel bundling service comprises displaying the booking interface of the travel bundling service within the frame.

19. The method of claim 12, further comprising transmitting a discounted fare for the particular flight itinerary to the travel bundling service, wherein receiving the package comprises receiving the package rate comprising the discounted fare for the particular flight itinerary.

20. The method of claim 12, further comprising displaying the package rate, wherein displaying the standalone rate for the particular flight itinerary comprises displaying a reward point-based standalone pricing for the particular flight itinerary, the reward points sourced from a reward account hosted by the airline and assigned to the customer, and wherein displaying the package rate comprises displaying a discounted reward points-based package rate for the travel-related good, the reward points sourced from a reward account the external vendor and assigned to the customer.
